(19) United States
(12) Patent Application Publication
(10) Pub. No.: US 2014/0086426 A1
(43) Pub. Date: Mar. 27, 2014

(54) MASKING SOUND GENERATION DEVICE, MASKING SOUND OUTPUT DEVICE, AND MASKING SOUND GENERATION PROGRAM

(71) Applicants: Takashi Yamakawa, Iwata-shi (JP); Masato Hata, Hamamatsu-shi (JP); Mai Koike, Hamamatsu-shi (JP)

(72) Inventors: Takashi Yamakawa, Iwata-shi (JP); Masato Hata, Hamamatsu-shi (JP); Mai Koike, Hamamatsu-shi (JP)

(73) Assignee: YAMAHA CORPORATION, Hamamatsu-shi, Shizuoka (JP)

(21) Appl. No.: 13/992,700

(22) PCT Filed: Dec. 7, 2011
(86) PCT No.: PCT/JP2011/078336

§ 371 Date: Dec. 6, 2013

(30) Foreign Application Priority Data
Dec. 7, 2010 (JP) 2010-272091
Nov. 11, 2011 (JP) 2011-247733

(51) Int. Cl. G10K 11/175

(52) U.S. Cl. CPC G10K 11/175
USPC 381/73.1

(57) ABSTRACT

There is provided a masking sound output device which prevents interference and an echo even in the case where plural apparatus output the same masking sounds. A masking sound generating unit 11 reproduces each of a disturbing sound, a background sound, and a dramatic sound repeatedly for a prescribed time each time. Return reproduction of each of the disturbing sound and the background sound is started with prescribed timing before it is reproduced fully for the prescribed time. The start timing of the return reproduction varies from one device to another. Unlike the disturbing sound and the background sound, the dramatic sound is not returned halfway; its reproduction timing is adjusted by inserting silent intervals. In particular, the silent interval length of the dramatic sound is varied randomly so that a listener does not recognize the repetition.

### TECHNICAL FIELD

The present invention relates to a masking sound generation device which generates a masking sound, a masking sound output device, and a masking sound generation program.

### BACKGROUND ART

Devices for reducing the degree of discomfort of a listener by outputting an environmental sound and thereby masking an uncomfortable sound such as a device noise (refer to Patent document 1, for example) have been proposed conventionally.

The device of the Patent document 1 uses, as environmental sounds, a monotonous sound which is less stimulative psychologically such as a murmur of a small stream and an intermittent sound such as a song of a bird.

### PRIOR ART DOCUMENTS

### Patent Documents

Patent document 1: JP-A-09-319389

### SUMMARY OF THE INVENTION

### Problems to be Solved by the Invention

However, where plural devices are installed, the same sounds are generated by different devices so as to be timed with each other or to be slightly deviated from each other in time. Therefore, the sound pressure distribution is made non-uniform depending on the listening position due to interference between sound waves. A sound may be enhanced or be less audible only at particular positions.

An object of the present invention is therefore to provide a masking sound output device which prevents a non-uniform sound pressure distribution even in the case where a plurality of masking sound output devices output the same masking sounds.

### Means for Solving the Problems

According to the invention, a masking sound output device comprises a masking sound generating section that generates a masking sound; and a masking sound output section that outputs the masking sound repeatedly with timing that varies from one device to another.

Since the above a masking sound is output repeatedly with timing which varies from one device to another, the degree of non-uniformity of the sound pressure distribution due to interference is lowered and a listener is allowed to feel a wide acoustic space. Therefore, even when plural conversations are being made at close positions as at dialogue counters in a bank, a prescription pharmacy, or the like, since a uniform masking sound can be output to nearby third persons, there does not occur an event that at some positions a masking sound is not heard or too large a masking sound causes a listener to feel uncomfortable.

It is desirable that the masking sound having a disturbing sound for disturbing a voice as a subject of masking, a background sound which is continuous, and a dramatic sound which is intermittent; that each of the disturbing sound and the background sound be return-output after it is output for a time which varies from one device to another; and that the dramatic sound be output repeatedly while silent intervals are inserted whose lengths vary from one device to another.

For example, the disturbing sound is a sound produced by altering a human voice on the time axis or the frequency axis so as to make it meaningless in terms of words (i.e., to make its content not understandable). The background sound is a sound that does not tend to attract attention of a listener and does not cause the listener to feel uncomfortable, such as a murmur of a small stream or a rustle of trees. Each of the disturbing sound and the dramatic sound is a steady sound. Therefore, even if the same sound data is reproduced repeatedly, it is difficult for a listener to recognize the repetitive reproduction. Therefore, a listener would not feel out of place even if return reproduction of sound data to last a prescribed time is started halfway instead of being reproduced fully. The return reproduction means a manner of reproduction in which, for example, reproduction of sound data to last 1 min is restarted from its head after it is reproduced for about 30 sec from its head. On the other hand, since the dramatic sound is a sound that is high in livening-up effect (e.g., a sound having a melody), a listener would feel out of place if it is stopped halfway. Therefore, for the dramatic sound, return reproduction is not started halfway. Instead, non-uniformity of the sound pressure distribution is lowered by outputting the dramatic sound for a predetermined time and then outputting it repeatedly while inserting silent intervals whose lengths vary from one device to another.

Since the dramatic sound is an intermittent sound, dramatic sounds may sound like an echo if the dramatic sounds are output from a plurality of masking sound output devices at short intervals. In view of this, it is desirable that the lengths of the silent intervals be adjusted so as to provide so long deviations in time that dramatic sounds are not recognized as an echo.

Satisfactory results are obtained as long as a return time of a sound, output first, of each of the disturbing sound and the background sound varies from one device to another. Even if sounds are output thereafter repeatedly with the same reproduction time, it is difficult for a listener to recognize the repetitive reproduction and the sound pressure distribution can be kept uniform.

On the other hand, as for the dramatic sound, a listener can easily recognize repetitive reproduction because plural sounds having pitch occur sequentially in time series. It is therefore preferable to vary the lengths of the silent intervals randomly using random numbers to prevent a listener from recognizing the repetition.

It is preferable that each of the disturbing sound and the background sound is output repeatedly with cross-fading. In particular, although the background sound is a steady natural sound, it may include a non-steady sound such as a song of a bird. The degree of out-of-place feeling that may be caused by return reproduction is thus lowered by cross-fading.

One method for deviating the masking sound output timing from one device to another is to generate random numbers using values (e.g., manufacturer's serial numbers) which are unique to respective devices and perform return reproduction or insert silent intervals according to the generated random numbers.

A mode is possible in which a set of disturbing sounds, a set of background sounds, and a set of dramatic sounds are stored individually and the output timing of each devices is deviated by combining a disturbing sound, a background sound, and a dramatic sound each time while adjusting the output timing between them. With this measure, it is not necessary to prepare different sets of sound data (having different reproduction times) for respective devices, that is, it becomes possible to store completely the same set of sound data in plural devices.

### Advantages of the Invention

The invention makes it possible to prevent a non-uniform sound pressure distribution even in the case where plural devices output the same masking sounds.

### BRIEF DESCRIPTION OF THE DRAWINGS

FIG. 1(A) outlines a rough configuration of a masking system which uses masking sound output device, and FIG. 1(B) is a block diagram showing the configuration of one masking sound output device.

FIG. 2 shows frequency characteristics of a disturbing sound, a background sound, and a dramatic sound.

FIG. 3 is a functional block diagram of a masking sound generating unit.

FIGS. 4(A)-4(C) are conceptual diagrams showing how a disturbing sound, a background sound, and a dramatic sound are reproduced.

FIGS. 5(A) and 5(B) show calculated sound pressure distributions.

FIGS. 6(A)-6(C) show example combinations of a disturbing sound, a background sound, and a dramatic sound.

### MODE FOR CARRYING OUT THE INVENTION

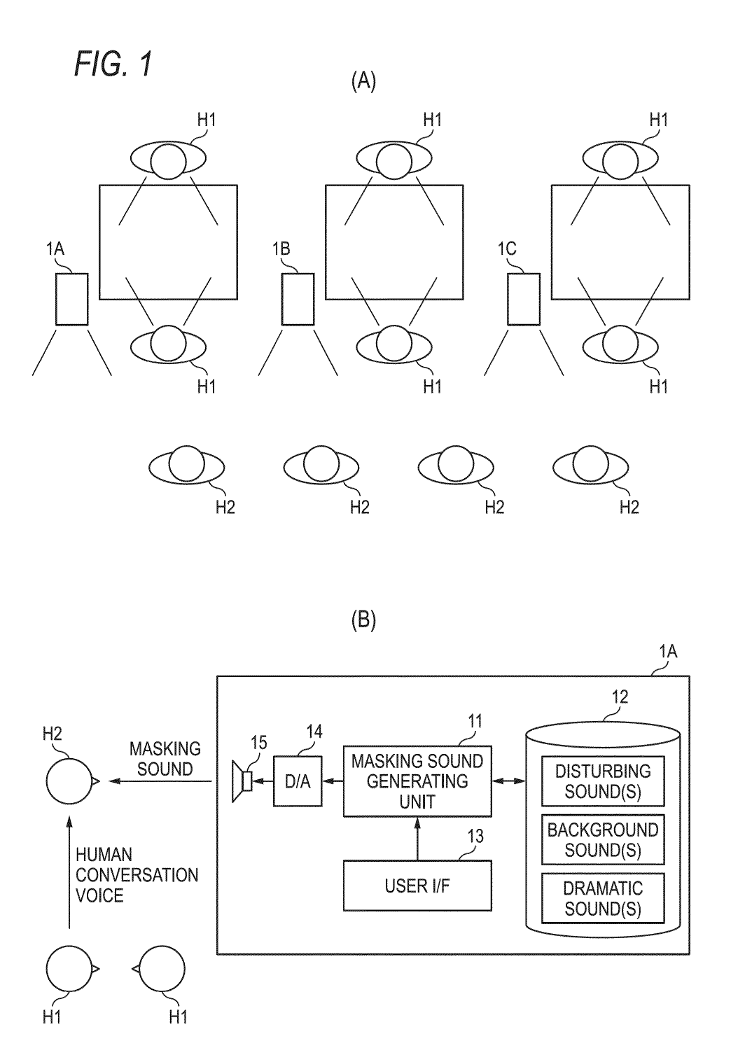

FIG. 1(A) shows a rough configuration (plan arrangement) of a masking system which uses a masking sound output device 1A according to the invention, and FIG. 1(B) is a block diagram showing the configuration of the masking sound output device 1A. The masking sound output device 1A is installed beside a dialogue counter in a bank, a prescription pharmacy, or the like and emit, to third persons, a masking sound so that they cannot understand the content of a conversation that is made across the counter. In the example of FIG. 1(A), there are three counters, two speakers H1 exist per counter, and masking sound output device 1A-1C are installed independently of each other. There are four third persons (listeners). However the numbers of speakers and listeners are not limited to those of this example. The number of masking sound output device is not limited to that of this example, either.

FIG. 1(B) shows the configuration of the masking sound output device 1A as a representative one, and the functions of the masking sound output device 1A will mainly be described. However, the other masking sound output device 1B and 1C have the same configuration and functions as the masking sound output device 1A.

The masking sound output device 1A includes a masking sound generating unit 11, a storage unit 12, a user interface (I/F) 13, a D/A conversion unit 14, and a speaker 15.

The masking sound generating unit 11 reads various kinds of audio data from the storage unit 12 and generates an audio signal (a digital audio signal) for a masking sound. The generated digital audio signal for a masking sound is converted into an analog audio signal by the D/A conversion unit 14. A masking sound of the analog audio signal is emitted from the speaker 15 and heard by a listener H2. A block for amplifying the audio signal is omitted in the figure; it may be such as to amplify either the analog audio signal or the digital audio signal. Instead of reading various kinds of audio data from the storage unit 12 and outputting a masking sound, the masking sound generating unit 11 may read various kinds of source sound data of a masking sound from the storage unit 12, generate a masking sound by altering the various read-out sound data, and output the generated masking sound.

The masking sound generating unit 11, which corresponds to a masking sound generating section and a masking sound output section, generates a masking sound signal on the basis of sound data stored in the storage unit 12 and outputs the masking sound signal. The masking sound may be any kind of sound as long as it can mask a sound. The masking sound is generated by combining a disturbing sound, a background sound, and a dramatic sound.

The disturbing sound is a sound for disturbing a masking target voice and is produced by altering a human voice on the time axis or the frequency axis so as to make it meaningless in terms of words (i.e., to make its content not understandable). The disturbing sound may be a sound produced by altering any of various source sounds of a masking sound according to the acoustic characteristics of a human voice. As such, the disturbing sound is a sound that sounds like a human voice but cannot be recognized as a human conversation voice. Thus, the disturbing sound may cause a listener to feel out of place depending on the listening environment. A listener may feel uncomfortable if he or she continues to hear such a disturbing sound or hears such a disturbing sound that is too loud. Therefore, it is preferable that the masking sound generating unit 11 combine a disturbing sound with a background sound and a dramatic sound.

The background sound is a sound that does not tend to attract attention of a listener in terms of auditory sense and does not cause the listener to feel uncomfortable, such as a murmur of a small stream or a rustle of trees. Using the background sound, the degree of discomfort that may be caused by the disturbing sound is lowered by increasing the silent noise level and thereby making the disturbing sound less liable to cause a listener to feel out of place. The dramatic sound is a sound that is high in livening effect such as intermittent musical sound. The dramatic sound serves to make the disturbing sound less liable to cause a listener to feel out of place in terms of auditory psychology by directing his or her attention also to the dramatic sound. By causing a listener H2 to hear a masking sound that is a combination of such a disturbing sound, background sound, and dramatic sound, the degree of discomfort of the listener H2 can be lowered while voices of speakers H1 are masked.

The background sound is an environmental sound that is generated steadily. The dramatic sound is any kind of sound as long as it is an intermittent sound that is high in livening effect. However, it is preferable that the dramatic sound have such characteristics as not to impair (the masking effect of) the disturbing sound and be able to lower the degree of discomfort in terms of auditory sense while allowing a listener to hear the disturbing sound as a sound of a sufficiently high level. The term “not to impair” means not to lower the masking effect of the disturbing sound itself. In the embodiment, the independent effects of the background sound and the dramatic sound (lowering the degree of discomfort or out-of-place feeling caused by the disturbing sound) are added to the masking effect of the disturbing sound itself. However, the addition of the background sound and the dramatic sound to the disturbing sound makes the sound pressure level of the masking sound somewhat higher than before the addition. The small increase of the sound pressure level of the masking sound may increase the masking effect a little. However, the increase of the sound pressure level does not directly lead to increase of the masking effect because the frequency characteristic of each of the background sound and the dramatic sound is different from that of the disturbing sound.

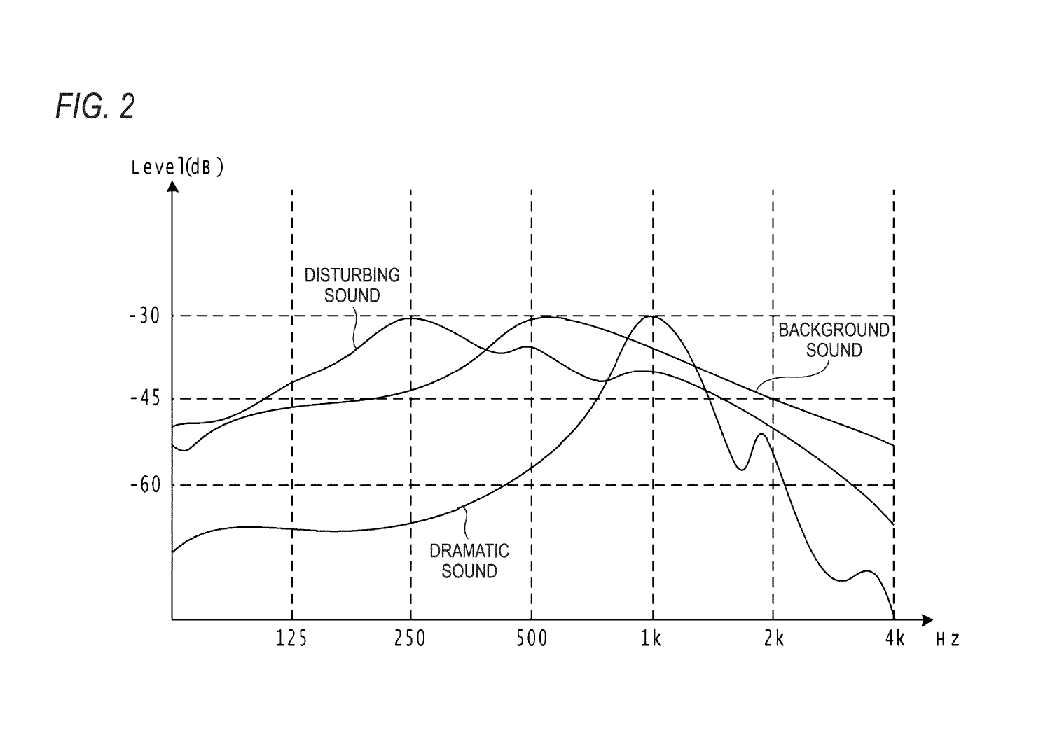

FIG. 2 shows frequency characteristics of a disturbing sound, a background sound, and a dramatic sound. However, the frequency characteristics shown in the figure are schematic examples for description and are not frequency characteristics of real audio signals. Numerical values of levels shown on the vertical axis are not absolute values and merely indicate relative frequency characteristic levels of the disturbing sound, the background sound, and the dramatic sound.

Since as mentioned above the disturbing sound is a sound that is produced by altering a human voice on the time axis or the frequency axis, its frequency characteristic is similar to the frequency characteristic of a human voice. To produce a disturbing sound by altering a human voice on the time axis, voices of particular speakers (plural persons (males and females)) are recorded. And each of those voices is turned to a meaningless voice (in terms of words) by, for example, dividing it into intervals having a constant length in each prescribed time and reads out an audio signal in each interval in the reverse direction. To produce a disturbing sound by altering a human voice on the frequency axis, it is turned to a meaningless voice (in terms of words) by extracting peaks (formants) of a spectrum envelope and changing particular formants that affect formation of words (e.g., turning peaks to dips). The disturbing sound may be either a general-purpose one that is generated from voices of plural persons (males and females) or a one generated from a voice of a speaker himself or herself. A further alternative mode is as follows. A microphone is provided in the masking sound output device and a voice of a speaker is acquired at the installation place of the masking sound output device. A disturbing sound is generated each time according to a voice acquired in this manner.

The example disturbing sound shown in FIG. 2 is a one generated by altering voices of plural persons (males and females) on the time axis, and its frequency characteristic has a highest peak around 250 Hz and extends in a band of about 100 Hz to 1 kHz (approximately the same as the band of human voices). Although peak frequencies vary with the pitch, disturbing sounds have a highest peak in a frequency range of about 100 to 400 Hz because they are generated from human voices.

As mentioned above, the background sound is a sound that is in a wide band and less stimulative psychologically, such as a murmur of a small stream or a rustle of trees. The background sound has a peak at a higher frequency than the disturbing sound (in the example of FIG. 2, its peak frequency is located at 250 Hz). In the example of FIG. 2, the frequency characteristic of the background sound has a highest peak around 500 Hz and extends in a band of about 200 Hz to 2 kHz. This makes it possible to lower the degree of discomfort caused by the disturbing sound while allowing a listener to hear the disturbing sound as a sound of a sufficiently high level. However, it suffices that the background sound have a higher main frequency component than the disturbing sound, and the peak frequency and the band are not limited to those of this example. For example, the frequency characteristic of the background sound may be such as to have an even higher peak frequency (e.g., about 1 kHz) or an even wider band (e.g., 100 Hz to 4 kHz) than that of this example. Furthermore, the index of a main component of a frequency characteristic is not limited to a peak frequency and may be of any kind. It may be another parameter such as the center of gravity of a frequency characteristic.

Has a higher peak frequency than even the background sound, the dramatic sound is most noticeable in auditory sense to attract attention of a listener. The dramatic sound has a narrower band than the disturbing sound so as to easily catch attention of a listener in auditory sense. The dramatic sound is a sound that is recognized as a musical sound (i.e., a sound of a musical instrument or a song). As such, the dramatic sound serves to attract attention of a listener and make the disturbing sound less noticeable psychologically. The example dramatic sound shown in FIG. 2 is one generated from a sound of the piano, and its frequency characteristic has a highest peak around 1 kHz and extends in a narrow band of about 700 Hz to 1.5 kHz. However, it suffices that the dramatic sound have a higher main frequency component than the disturbing sound, and the peak frequency is not limited to that of this example. For example, the frequency characteristic of the dramatic sound may be such as to have an even higher peak frequency (e.g., about 2 kHz) or a lower peak frequency (e.g., about 500 kHz which is the same as the peak frequency of the background sound) than that of this example. It suffices that the dramatic sound have a narrower band than the disturbing sound, and the band may be wider (e.g., 200 Hz to 1 kHz) than that of the example of FIG. 2. Furthermore, the index of a main component is not limited to a peak frequency. For example, it may be the center of gravity of a frequency characteristic.

The peak levels of the disturbing sound, the peak levels of the background sound, and the dramatic sound do not have very large differences or are approximately the same as in the example of FIG. 2 (about −30 dB). A mode is possible in which the peak level of each of the background sound and the dramatic sound is lower than that of the disturbing sound. However, the dramatic sound is a non-steady sound having a narrower band than the disturbing sound and the background sound, and is lower in equivalent noise level (i.e., in volume) than the disturbing sound and the background sound. As such, the dramatic sound serves to lower the degree of discomfort while attracting attention of a listener.

Since the masking sound is a combination of the above-described disturbing sound, background sound, and dramatic sound, it is possible to disable a listener to understand the content of a voice of a speaker and to cause the listener to hear a sound that lowers the degree of out-of-place feeling that may be caused by the disturbing sound without impairing its masking effect. As a result, the degree of discomfort of a listener can be lowered even in the case where the masking target is a human voice.

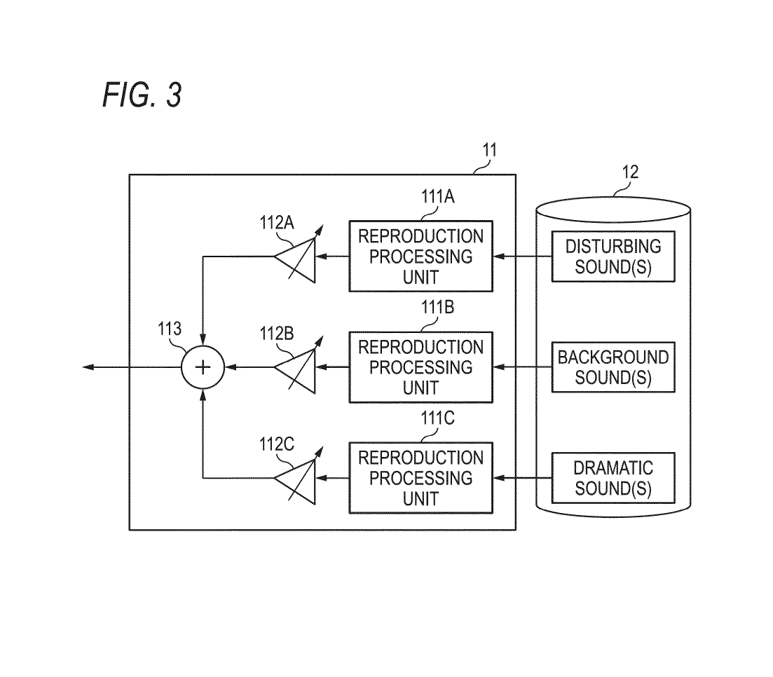

Next, a masking sound generation process will be described in s specific manner. FIG. 3 is a functional block diagram of the masking sound generating unit 11. In terms of functionality, the masking sound generating unit 11 is equipped with reproduction processing units 111A, 111B, and 111C, level adjusting units 112A, 112B, and 112C, and a combining unit 113.

The reproduction processing unit 111A reads sound data of a disturbing sound from the storage unit 12 and performs reproduction processing on it. In doing so, if the sound data of a disturbing sound is encoded compressed data, the reproduction processing unit 111A decodes it into a digital audio signal. Likewise, the reproduction processing unit 111B reads sound data of a background sound from the storage unit 12 and performs reproduction processing on it. The reproduction processing unit 111C reads sound data of a dramatic sound from the storage unit 12 and performs reproduction processing on it.

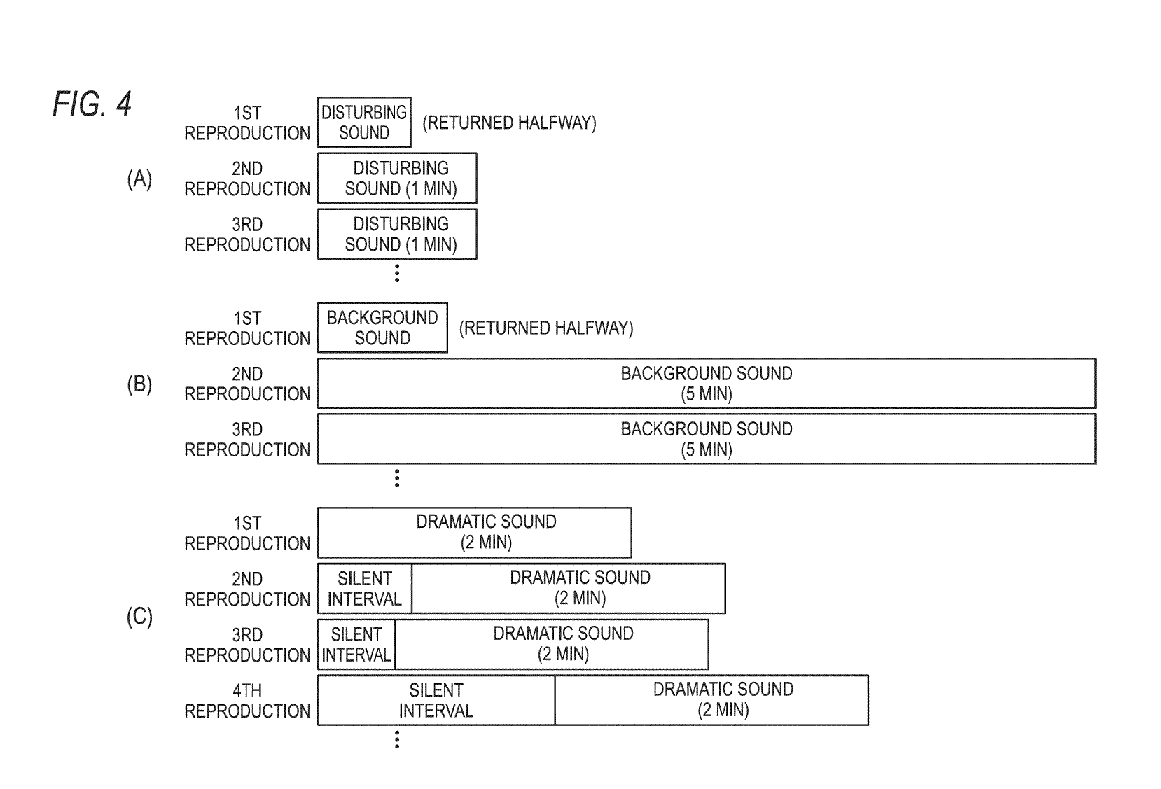

The reproduction processing units 111A, 111B, and 111C adjusts the audio data reproduction timing (audio signal output timing). A masking sound output means of the invention is thus implemented. FIGS. 4(A)-4(C) are conceptual diagrams showing how a disturbing sound, a background sound, and a dramatic sound are reproduced.

First, the disturbing sound is a steady sound that is based on human voices but is meaningless in terms of words. Even if the disturbing sound is reproduced repeatedly, it is difficult for a listener to recognize the repetitive reproduction. Therefore, sound data that lasts a prescribed, relatively short time (in the example of FIG. 4(A), 1 min) is reproduced repeatedly.

Although the background sound is basically a steady natural sound, it may include non-steady sounds (e.g., a rustle of trees may stop temporarily or a song of a bird may be inserted). Therefore, sound data that lasts a prescribed time (in the example of FIG. 4(B), 5 min) that is longer than the reproduction time of the sound data of the disturbing sound is reproduced repeatedly. When the sound data that lasts the prescribed time (5 min) is reproduced repeatedly, its reproduction level or tone quality may be varied each time.

As for each of the disturbing sound and the background sound, return reproduction of the sound data is started at a prescribed time point before it is reproduced fully for the prescribed time. The return reproduction means a manner of reproduction in which sound data is not reproduced fully from its head and, instead, reproduction of the sound data is restarted from its head after it is reproduced for a certain time (e.g., about 30 sec) from its head. For example, as shown in FIG. 4(A), when the sound data of the disturbing sound is reproduced for the first time, return reproduction of the sound data is started halfway, that is, before a lapse of the prescribed time (1 min). In the second and following reproduction operations (repetitive reproduction), the sound data of the disturbing sound is reproduced for the prescribed time.

The time point when return reproduction is started varies from one device to another. For example, return reproduction is started after a lapse of 3 sec, 5 sec, and 7 sec in the masking sound output device 1A, 1B, and 1C, respectively. With this measure, even if these devices are powered on simultaneously, the disturbing sounds are output from these devices with deviations of several seconds.

One method for varying the start time point of return reproduction from one device to another is to use random numbers that are specific to the respective devices. For example, times specific to the respective devices are obtained by generating random numbers Rn (=0 to 1) using values (e.g., manufacturer's serial numbers) that are unique to the respective devices and calculating times t on the basis of the generated random numbers Rn. That is, reproduction times of first sound data reproduction operations are determined according to an equation t=a+(b−a)·Rn (a and b are a minimum value (e.g., 1 sec) and a maximum value (e.g., 10 sec), respectively). The values (e.g., manufacturers serial numbers) that are unique to the respective devices are stored in the storage units 12, ROMs (not shown), or the like.

As shown in FIG. 4(B), when the sound data of the background sound is reproduced for the first time, return reproduction of the sound data is started halfway, that is, before a lapse of the prescribed time (5 min). In the second and following reproduction operations (repetitive reproduction), the sound data of the background sound is reproduced for the prescribed time. In the same manner as described above, times specific to the respective devices are obtained by generating random numbers Rn (=0 to 1) using values (e.g., manufacturer's serial numbers) that are unique to the respective devices and calculating times t on the basis of the generated random numbers Rn. That is, reproduction times of first sound data reproduction operations are determined according to the equation t=a+(b−a)·Rn (a and b are a minimum value (e.g., 1 sec) and a maximum value (e.g., 10 sec), respectively). However, since random numbers are used, the time t for the disturbing sound and the time t for the background sound are made different from each other and hence return reproduction operations of the disturbing sound and the background sound are started at different time points. Therefore, in even each device, the disturbing sound and the background sound are output with a deviation in time.

As mentioned above, the background sound may include non-steady sounds. Therefore, for example, a listener may feel out of place because a song of a bird is stopped halfway. In view of this, as for the background sound, it is preferable that to lower the degree of discomfort due to return reproduction by performing the return reproduction with cross-fading. Return reproduction with cross-fading may also be performed for another kind of sound (e.g., disturbing sound).

On the other hand, as described above, the dramatic sound is an intermittent sound. Therefore, sound data that lasts a prescribed, relatively short time (in the example of FIG. 4(C), 2 min) that is longer than the reproduction time of the sound data of the disturbing sound and shorter than the reproduction time of the sound data of the background sound is reproduced repeatedly. However, since the dramatic sound may be a sound having a melody such as a piano sound, as shown in FIG. 4(C) its reproduction timing is adjusted by inserting silent intervals instead of performing return reproduction as in the case of the disturbing sound and the background sound. In particular, the dramatic sound is such a sound that it is easier for a listener to recognize its repetitive reproduction, because plural sounds having pitch occur sequentially in time series. Therefore, the length of the silent interval is varied randomly to prevent a listener from recognizing the repetitive reproduction. The length of the silent interval is varied using the same technique as described above. That is, times specific to the respective devices are obtained by generating random numbers Rn (=0 to 1) using numerical values (e.g., manufacturer's serial numbers) that are unique to the respective devices and calculating times t on the basis of the generated random numbers Rn. That is, random silent interval lengths that are specific to the respective devices are determined according to the equation t=a+(b−a)·Rn. However, for the dramatic sound, it is preferable to insert relatively long silent intervals by setting a and b at several tens of seconds and several minutes, respectively. For example, if the same dramatic sounds (e.g., having the same melody) were output from the plural devices with slight deviations in time, a listener would hear the same sounds that are deviated slightly in time and might feel uneasy about by them like an echo. It is therefore desirable to adjust the lengths of the silent intervals so as to produce deviations in time that are long enough to prevent a listener from recognizing them as an echo.

Determined on the basis of random numbers, the silent interval lengths t are made different from the repetition times t of the disturbing sound and the background sound. Therefore, in even each device, the disturbing sound, the background sound, and the dramatic sound are output with deviations in time.

By adjusting the output timing between the disturbing sound, the background sound, and the dramatic sound in the above-described manner, even if the devices having the same configuration (plural masking sound output device 1A-1C) which do not have a communication function etc. and are installed independently of each other are powered on simultaneously, the disturbing sound, the background sound, and the dramatic sound that are output from each device have deviations in time, whereby the non-uniformity of a sound pressure distribution can be lowered.

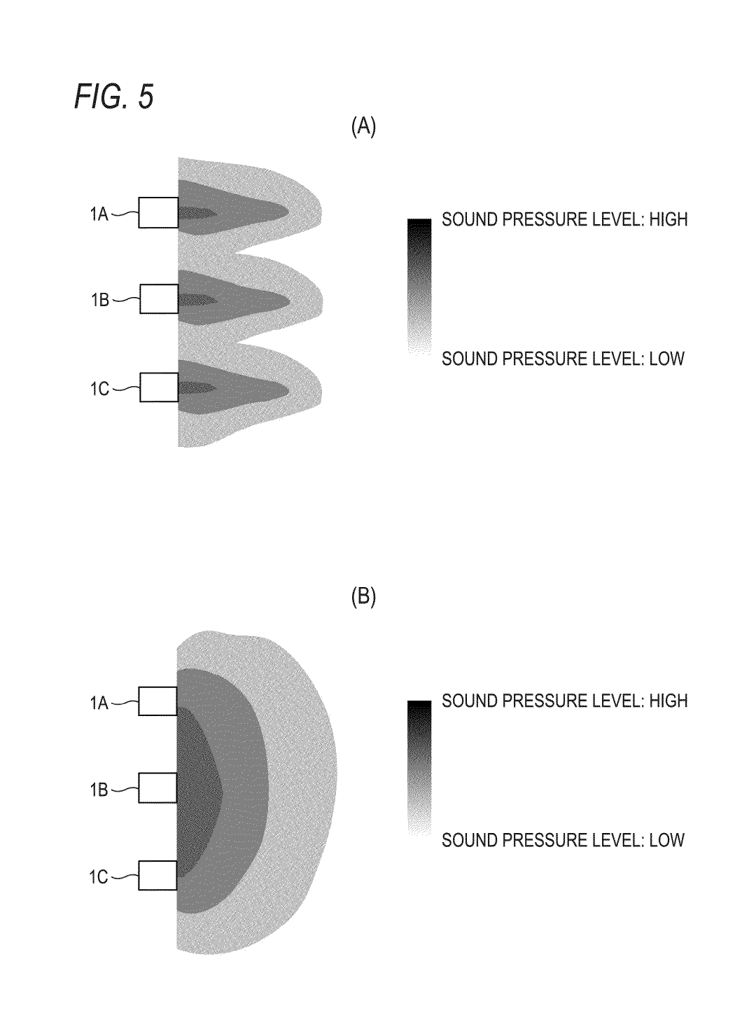

FIGS. 5(A) and 5(B) show calculated sound pressure distributions. FIG. 5(A) shows a sound pressure distribution that is obtained when masking sounds (only disturbing sounds) are output simultaneously from the masking sound output device 1A-1C. As seen from this figure, when the plural devices are powered on simultaneously and the same sounds are output so as to be timed with each other, there occur positions where the sounds strengthen each other to increase the sound pressure level and positions where, conversely, the sound pressure level is low.

On the other hand, FIG. 5(B) shows a sound pressure distribution that is obtained when the output timing between disturbing sounds, background sounds, and dramatic sounds is adjusted so that masking sounds are not output simultaneously. As seen from this figure, in the masking system according to the embodiment, disturbing sounds, background sounds, and dramatic sounds are output from the devices with deviations in time, the degree of non-uniformity of the sound pressure distribution due to interference is lowered and a uniform sound pressure distribution is thereby realized. Therefore, even when plural conversations are being made at dose positions as at dialogue counters in a bank, a prescription pharmacy, or the like, since a uniform masking sound can be output to nearby third persons, a sound image is not oriented around a particular device and, instead, a listener feels a wide acoustic space (like the masking sound is reverberating in the whole space). This prevents a problem that at some positions a masking sound is not heard or too large a sound causes a listener to feel uncomfortable.

Each of the plural masking sound output device is stored with a disturbing sound, a background sound, and a dramatic sound, and generates and outputs a masking sound while adjusting their output timing. Therefore, it is not necessary that each of the set of disturbing sounds, the set of background sounds, and the set of dramatic sounds stored in the plural devices be different sound data (having different reproduction times). Instead, each set can be the same sound data. It is not necessary either to adjust the output timing between the plural devices using a communication function; sound signals can be output with deviations in time even in a state that the plural devices are installed independently of each other.

In the above-described example, random numbers are generated using values (e.g., manufacturers serial numbers) that are unique to the respective devices and times specific to the respective devices are calculated on the basis of the generated random numbers. Alternatively, for example, the first reproduction times of the disturbing sound and the background sound and the silent interval lengths of the dramatic sound may be determined by storing random numbers specific to each device in the storage unit 12, a ROM (not shown), or the like in advance and reading out the stored random numbers. It is also possible to A/D-convert circuit noise to employ a resulting value as an initial value of random numbers or take in resulting values themselves as random numbers. A user of each device may specify first reproduction times of the disturbing sound and the background sound and silent interval lengths of the dramatic sound through the user I/F 13. Furthermore, the reproduction times and the silent interval lengths may be varied by connecting the plural masking sound output device to another processing apparatus such as a personal computer and causes the other processing apparatus to supply different sets of values (numbers or the like) to the respective masking sound output device.

In the above-described example, the reproduction timing between the plural apparatus is independent of the frequency, that is, does not vary with the frequency. Alternatively, for example, the plural apparatus may be given unique phase characteristics (phase frequency characteristics) using all-pass filters and so that the reproduction timing varies with the frequency. With this measure, the sound pressure distribution is not made non-uniform in all bands simultaneously and, instead, non-uniformity becomes dependent on the frequency. Thus, the sound pressure distribution of a masking sound can be prevented even more efficiently from becoming non-uniform.

In the above-described example, random numbers are generated using values (e.g., manufacturers serial numbers) that are unique to the respective devices. Since values based on which random numbers are to be generated are unique to the respective devices, different sets of random numbers are necessarily generated in the respective devices.

In the above-described example, each of the disturbing sound and the background sound is a steady sound. Therefore, even though the sound data is returned halfway only in the first reproduction and thereafter reproduced repeatedly so as to be returned after a lapse of the same reproduction time, a listener does not recognize repeated reproduction easily and the sound pressure distribution can be kept uniform. However, return reproduction may be started in the second or later reproduction. Naturally, the sound data may be returned halfway randomly in every reproduction operation. Instead of the disturbing sound or the background sound, the whole of a masking sound obtained by combining the individual sounds may be subjected to return reproduction.

The disturbing sound, the background sound, and the dramatic sound which are generated in the above described manner are input to the level adjusting units 112A, 112B, and 112C, respectively. The level adjusting units 112A, 112B, and 112C perform level adjustments on the disturbing sound, the background sound, and the dramatic sound and output resulting sounds to the combining unit 113, respectively. The level adjustment amounts for the disturbing sound, the background sound, and the dramatic sound are determined in advance so that, for example, their peak levels become approximately identical (see FIG. 2). Alternatively, level adjustments may be made according to manipulations that are received through the user I/F 13. A manipulation of turning on or off the dramatic sound (or background sound) may be received. If a turn-off manipulation is received, the level adjusting unit 112C (or 112B) performs processing of setting the level to zero. Alternatively, the reproduction processing unit 111C (or 111B) abstains from performing reproduction processing.

The combining unit 113 combines the disturbing sound, the background sound, and the dramatic sound, and outputs a resulting sound to the downstream D/A conversion unit 14.

The embodiment is not limited to the case that only one sound data is stored in the storage unit 12 for each of the disturbing sound, the background sound, and the dramatic sound; plural audio data may be stored for each of the disturbing sound, the background sound, and the dramatic sound. In the latter case, the masking sound generating unit 11 selects a particular one of the plural audio data and reads it out. Where plural audio data may be stored for each kind of sound, audio data that is specified by a user through the user I/F 13 may be selected. Alternatively, audio data may be selected according to a predetermined combination table (stored in the storage unit 12).

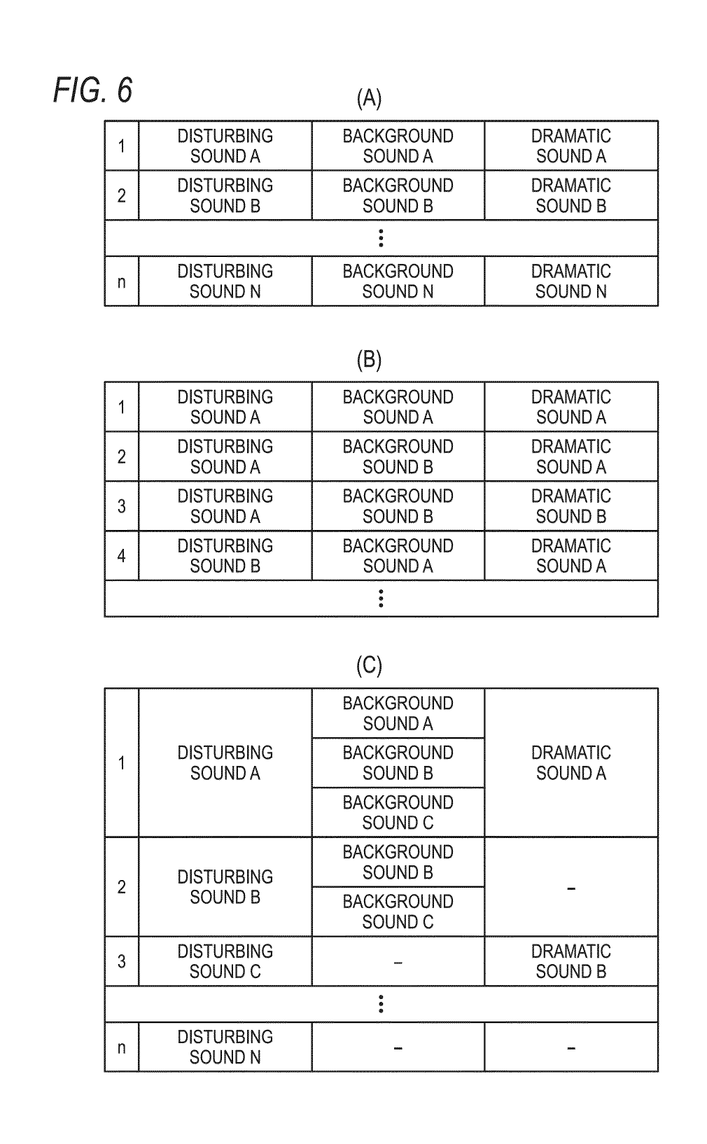

FIGS. 6(A), 6(B), and 6(C) show example combination tables. Each of these tables is stored in the storage unit 12 and referred to by the masking sound generating unit 11. First, FIG. 6(A) shows an example in which different background sounds and different dramatic sounds are correlated with respective disturbing sounds. In this case, a user specifies a combination number through the user I/F 13. For example, if a combination number “1” is selected, a combination of disturbing sound A, background sound A, and dramatic sound A is selected. The masking sound generating unit 11 reads the audio data for disturbing sound A, background sound A, and dramatic sound A from the storage unit 12 and generates an audio signal for a masking sound based on them. On the other hand, if a combination number “2” is selected, a combination of disturbing sound B, background sound B, and dramatic sound B is selected and the masking sound is changed. For example, if disturbing sound A is a general-purpose one produced using voices of plural persons (males and females) and disturbing sound B is a one produced using a voice of a speaker himself or herself, the masking effect is changed. When switching is made from one background sound to another, the atmosphere of the place is changed.

When the combination is switched, the probability of occurrence of interference is low unless switching is made to the same combinations simultaneously. It is preferable that return reproduction be started halfway during reproduction of each of a first disturbing sound and a first background sound after the switching. Return reproduction may be started using a return reproduction start time (first reproduction time) itself calculated before the switching. Alternatively, a new reproduction time may be calculated by generating a random number again every time the combination is switched.

The combination table may contain level adjustment amounts of the respective sounds. It is preferable that the sound volume, in terms of the auditory sense of a listener, of the disturbing sound not vary if the sound volume of a masking sound generated by a combination remains the same. Therefore, the level balance is determined in advance by, for example, performing an experiment so that a background sound and a dramatic sound are reproduced in such a manner that a selected disturbing sound does not cause a listener to feel out of place or sense a variation in volume.

Only the disturbing sound or the background sound can be switched by storing plural sets of sound data individually in the manner being described. For example, if switching is made from the combination number 1 to the combination number 4 in the example of FIG. 6(B) to switch only the disturbing sound, only the masking effect is changed without changing the atmosphere of the place. If switching is made from the combination number 1 to the combination number 2 to switch only the background sound, the atmosphere of the place can be changed without changing the masking effect. In this case, it is desirable that the sound volume in terms of auditory sense be adjusted so that the masking effect does not vary even if different masking sounds (combinations of a disturbing sound and a background sound or combinations of a disturbing sound, a background sound, and a dramatic sound) are selected as long as the sound volume remains the same. For example, where the sound volume of a voice as a subject of masking is kept constant, the level balance between the disturbing sound, the background sound, and the dramatic sound or the final volume of the masking sound is managed so that the difficulty of hearing a voice (at a certain position) does not vary even when different masking sounds are selected.

As shown in FIG. 6(C), a mode in which plural background sounds are mixed together for a single disturbing sound and a mode in which no dramatic sound is reproduced for a certain disturbing sound are possible. Where plural background sounds are mixed together, the first reproduction times of the respective background sounds are set different from each other. A mode in which no background sound is reproduced (combination number 3) and a mode in which only a disturbing sound is reproduced (combination number n) are also possible.

In the embodiment, the disturbing sound, the background sound, and the dramatic sound are stored individually and combined together each time output is made. Alternatively, it is possible to store sound data of combined masking sounds are stored in advance and reproduce the sound data.

The masking sound output device 1A need not always be a dedicated apparatus, and can be implemented by using hardware and software of a general-purpose information processing apparatus such as a personal computer. The masking sound output device 1A can be implemented by using a program which causes a general-purpose processing apparatus such as a personal computer to perform the above-described operation of the masking sound output device.

The above program can be provided in a state that it is stored in a computer-readable recording medium such as a magnetic recording medium (magnetic tape, HDD, FD, or the like), an optical recording medium (CD, DVD, or the like), a magneto-optical recording medium, or a semiconductor memory. It is also possible to download the above program over a network such as the Internet.

The present application is based on Japanese Patent Application No. 2010-272091 filed on Dec. 7, 2010 and Japanese Patent Application No. 2011-247733 filed on Nov. 11, 2011, the disclosures of which are incorporated herein by reference.

### INDUSTRIAL APPLICABILITY

The masking sound output device according to the invention can prevent a non-uniform sound pressure distribution even in the case where plural apparatus output the same masking sounds.

### DESCRIPTION OF REFERENCE NUMERALS AND SIGNS

H1 . . . Speaker
H2 . . . Listener
1A, 1B, 1C . . . Masking sound output device
11 . . . Masking sound generating unit
12 . . . Storage unit
14 . . . D/A conversion unit
15 . . . Speaker

1. A masking sound output device comprising:
a masking sound generating section that generates a masking sound; and
a masking sound output section that outputs the masking sound repeatedly with timing which varies from one device to another.

2. The masking sound output device according to claim 1, wherein the masking sound output section determines the timing using a value which is unique to each device.

3. The masking sound output device according to claim 1, wherein the masking sound is configured by a disturbing sound for disturbing a voice, a background sound which is continuous, and a dramatic sound which is intermittent;
wherein the masking sound output section return-outputs each of the disturbing sound and the background sound after outputting the disturbing sound and the background sound for a time which varies from one device to another; and
wherein the masking sound output section outputs the dramatic sound repeatedly while inserting silent intervals whose lengths vary from one device to another.

4. The masking sound output device according to claim 3, wherein the lengths of the silent intervals are set so as to correspond to times with which dramatic sounds are not recognized as an echo.

5. The masking sound output device according to claim 3, wherein a return time of each of the disturbing sound and the background sound which the masking sound output section outputs first varies from one device to another.

6. The masking sound output device according to claim 3, wherein the masking sound output section outputs the dramatic sound so that the lengths of the silent intervals vary randomly from one device to another.

7. The masking sound output device according to claim 3, wherein the masking sound output section outputs the disturbing sound or the background sound repeatedly with cross-fading.

8. The masking sound output device according to claim 1, wherein the masking sound generating section generates the masking sound with timing which varies from one device to another; and
wherein the masking sound output section outputs the masking sound repeatedly with timing which varies from one device to another by repeatedly outputting the masking sound generated with timing which varies from one device to another.

9. The masking sound output device according to claim 1, comprising:
a storage section configured to store a set of disturbing sounds, a set of background sounds, and a set of dramatic sounds individually,
wherein the masking sound generating section generates the masking sound by reading a disturbing sound, a background sound, and a dramatic sound stored in the storage section and combining the disturbing sound, the background sound, and the dramatic sound while adjusting output timing between the disturbing sound, the background sound, and the dramatic sound.

10. A masking sound output system having a plurality of masking sound output devices according to claim 1, wherein each masking sound output device outputs the masking sound with timing which varies from one device to another.

11. A program for causing a masking sound output device to execute:
a masking sound generating step of generating a masking sound; and
a masking sound output step of outputting the masking sound repeatedly with timing which varies from one device to another.
